(19) United States
(12) Patent Application Publication
(10) Pub. No.: US 2010/0207802 A1
(43) Pub. Date: Aug. 19, 2010

(54) G-SENSOR REMOTE CONTROLLER

(76) Inventors: Yung-Hung CHIH, Shulin City (TW); Ching-Wen Yeh, Shulin City (TW)

Correspondence Address: Muncy, Geissler, Olds & Lowe, PLLC, 4000 Legato Road, Suite 310, FAIRFAX, VA, 22033, US

(21) Appl. No.: 12/372,421

(22) Filed: Feb. 17, 2009

(51) Int. Cl. G08C 17/02

(52) U.S. Cl. 341/176

(57) ABSTRACT

A G-sensor (gravity sensor) remote controller is characterized in that at least a G-sensor and a microprocessor are provided within the main body of the remote controller. Each G-sensor provided in the main body of the remote controller is used for sensing the tapping action of a user to produce sensing signals and different sensing signals can be produced according to the area on the main body the user taps or the tapping frequency within a period of time. The microprocessor provided in the main body of the remote controller is electrically connected with the G-sensor and for processing the sensing signals from the G-sensor to control the function setting of the remote controller itself or other electric apparatuses.

### TECHNICAL FIELD

The present invention relates to a remote controller and, more particularly, to a G-sensor (gravity sensor) remote controller, where at least a G-sensor is provided in the main body of the remote controller for sensing the tapping action of a user in order to control the remote controller itself or other electric apparatuses.

### BACKGROUND

With the progress in wireless transmission technology in recent years, electric apparatuses are usually equipped with wireless transmission receivers for convenient control. Thereby, users can control electric apparatuses remotely by using remote controllers adopting wireless transmission technology and able to emit radiation beams (such as infrared rays).

In daily lives, people can utilize remote controllers to control various electric apparatuses, such as televisions, sound systems, air conditioners, DVD players, electric fans, electric lamps, electric heaters, and dehumidifiers.

Please refer to FIG. 6 showing a conventional remote controller. As shown in this figure, the conventional remote controller “a1” comprises a body “a10”, a circuit board provided in the body (not shown in this figure), function keys “a12” provided on the external surface of the body, and a wireless transmitter “a14” provided at the anterior of the body. When using the remote controller, people can execute different functions by pressing different function keys “a 12”.

In order to render a remote controller multi-functional, it ought to dispose more function keys on the panel of the remote controller. However, it is time-consuming for users to find out a certain function key on the body of a remote controller when in use. Besides, if a controller is provided with too many function keys thereon, the functions of function keys can be shown only by simple patterns rather than written words since the size of the panel on the remote controller is limited. In this case, it will be not convenient for people to use the remote controller if they are not acquainted with the definitions corresponding to the patterns.

In order to solve above shortcomings, inventor had the motive to study and develop the present invention. After hard research and development, the inventor provides a G-sensor (gravity sensor) remote controller that is convenient to use without any problems resulted from the use of function keys, so that users can use the remote controller conveniently just by their tapping action to control the remote controller itself or other electric apparatuses.

### SUMMARY OF THE DISCLOSURE

An object of the present invention is to provide a G-sensor (gravity sensor) remote controller that is provided with at least a G-sensor within the main body thereof. Thereby, users can use the remote controller conveniently and easily just by tapping different areas on the main body of the remote controller or changing the tapping frequency within a period of time to control different electric apparatuses.

In order to achieve above object, the present invention provides a G-sensor remote controller, which is characterized in that at least a G-sensor and a microprocessor are provided within the main body of the remote controller. Each G-sensor provided in the main body of the remote controller is for sensing the tapping action of a user to produce sensing signals while the microprocessor provided in the main body of the remote controller is electrically connected with the G-sensor and for processing the sensing signals from the G-sensor to control the function setting of the remote controller.

Besides, the present invention also provides a G-sensor remote controller for controlling electric apparatuses and the remote controller comprises a main body, at least a G-sensor, a microprocessor, and a transmitting unit. The G-sensor is provided in the main body of the remote controller and for sensing the tapping action of a user to produce sensing signals. The sensing signals from the G-sensor are processed by the microprocessor that is provided in the main body and electrically connected with the G-sensor to produce control commands of controlling corresponding electric apparatuses. The control commands are transmitted by a transmitting unit to the electric apparatuses for control.

In practice, the G-sensor is disposed near the external surface of the main body of the remote controller.

In practice, different sensing signals are produced from the G-sensor according to the area of the main body of the remote controller the user taps.

In practice, different sensing signals are produced from the G-sensor according to the tapping frequency within a period of time.

The following detailed description, given by way of examples or embodiments, will best be understood in conjunction with the accompanying drawings.

### BRIEF DESCRIPTION OF THE DRAWINGS

FIG. 1 is a function-block diagram showing a first embodiment of a G-sensor (gravity sensor) remote controller of the present invention.

FIG. 2 shows a sectional view of the first embodiment of the G-sensor remote controller of the present invention.

FIG. 3A shows a using state diagram of the first embodiment of the present invention.

FIG. 3B shows another using state diagram of the first embodiment of the present invention.

FIG. 3C shows another using state diagram of the first embodiment of the present invention.

FIG. 4 shows a sectional view of a second embodiment of the G-sensor remote controller of the present invention.

FIG. 5A shows a using state diagram of the second embodiment of the present invention.

FIG. 5B shows another using state diagram of the second embodiment of the present invention.

FIG. 6 is a perspective view showing a conventional remote controller.

### DETAILED DESCRIPTION

The present invention discloses a G-sensor (gravity sensor) remote controller characterized in that: at least a G-sensor and a microprocessor are provided within the main body of the remote controller. Each G-sensor is provided in the main body of the remote controller for sensing the tapping action of a user to produce sensing signals. The microprocessor provided in the main body of the remote controller is electrically connected with the G-sensor and used for processing the sensing signals from the G-sensor to control the function setting of the remote controller.

In practice, the G-sensor is preferably disposed near the external surface of the main body of the remote controller and different sensing signals are produced from the G-sensor according to the area of the main body of the remote controller the user taps or according to the tapping frequency within a period of time.

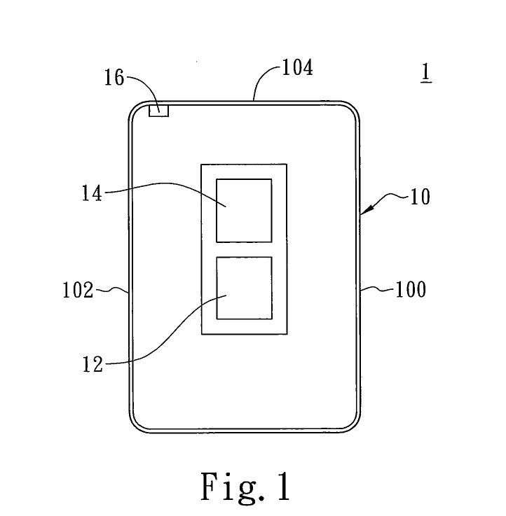

Please refer to FIGS. 1, 2, and 3A showing a first embodiment of a G-sensor remote controller according to the present invention. The G-sensor remote controller 1 of the present invention comprises a main body 10, a G-sensor 12, a microprocessor 14, a transmitting unit 16, and a screen 18. As shown in these figures, the G-sensor 12 and the microprocessor 14 are provided in the main body 10 and the microprocessor 14 is in electrically connected with the G-sensor 12. The transmitting unit 16 is provided at the anterior of the main body 10 and electrically connected with the microprocessor 14.

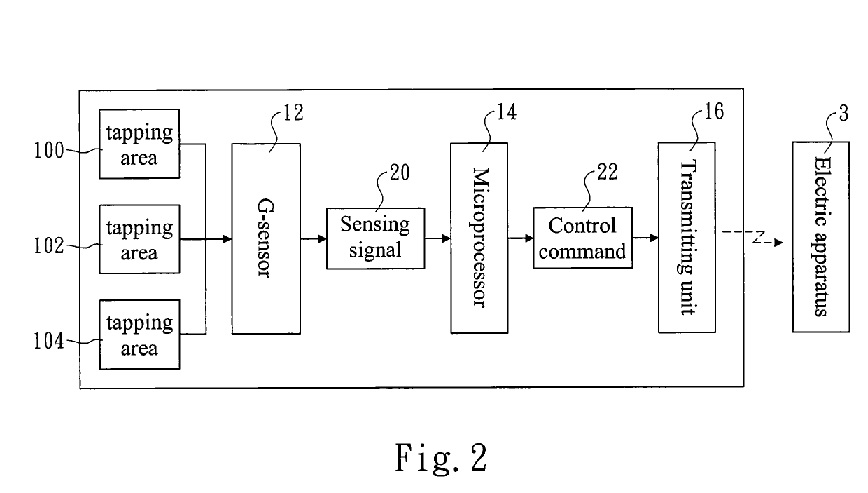

With respect to the use of the G-sensor remote controller, as shown in FIG. 2, when a user taps the tapping areas 100, 102, 104, the G-sensor 12 will produce different sensing signals 20 according to the area tapped by the user and the produced sensing signals 20 are conveyed to the microprocessor 14. After recognizing the sensing signals 20, the microprocessor 14 will process the sensing signals 20 to form control commands 22 that are specific for certain corresponding electric apparatuses and send the control commands 22 to the transmitting unit 16. Finally, the control commands 22 are sent to corresponding electric apparatuses 3 by the transmitting unit 16 for control.

In this embodiment, above tapping areas 100, 102, 104 are respectively provided at right-lateral, left-lateral, and top-lateral sides. This arrangement is just for exemplified purpose. When in practice, a single side may be provided with two or more tapping areas. Or, tapping areas also can be disposed beneath the front or back surface of the main body other than lateral sides. Besides, suitable marks can be provided on the surface of the main body to label these tapping areas for users to discern each tapping area's function and choose one of them quickly.

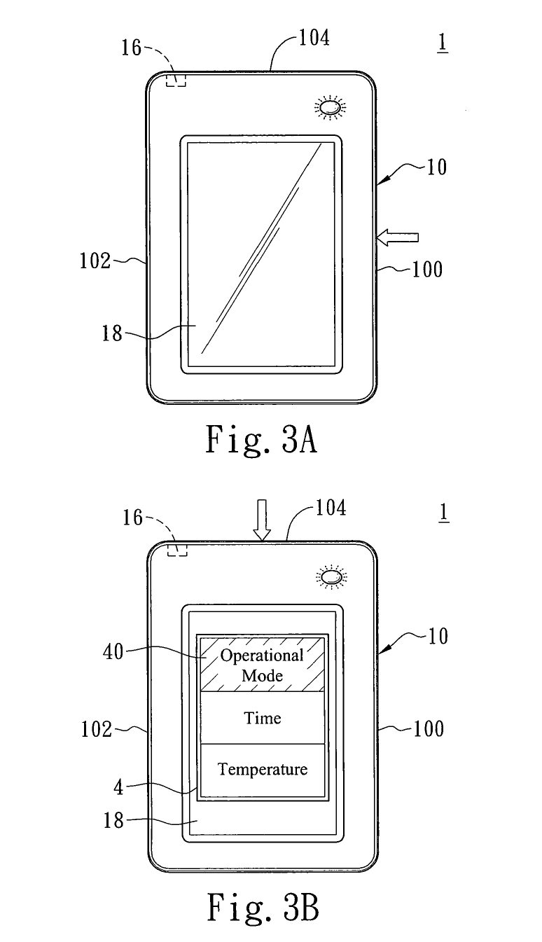

Please refer to FIGS. 3A to 3C showing the using state diagrams of the G-sensor remote controller according to the present invention. As shown in these figures, when a user taps the tapping area 100, the power of the electric apparatus can be turned on after the G-sensor detects that the tapping area 100 is tapped. When the tapping area 104 is tapped, a function menu 4 including a plurality of choices 40 can be shown on the screen 18. Moreover, users can set or correct time shown on the G-sensor remote controller or on the electric apparatus by tapping different tapping areas.

As shown in FIGS. 3B and 3C, an example of controlling an air conditioner is explained in the following. In this example, the function menu 4 including three choices 40: operational mode, time, and temperature. Users can move an indicating mark to select a desired choice by tapping different tapping areas 102, 104 on the main body 10. When users select the up most choice 40, sub-choices of this choice will be present on the screen 18. As shown in FIG. 3C, the sub-choices including air conditioning, heating, and dehumidifying are present on the screen 18 and users can further select any of these sub-choices.

There are various modes to move an indicating mark on a screen or selecting a choice or a sub-choice. Only two modes are exemplified and described in the following. In one mode, there is only one tapping area and different sensing signals can be produced by the G-sensor according to the tapping frequency within a period of time (one or several seconds). For example, if a user taps the tapping area 100 once within a second, the electric apparatus in control can be turned on. The electric apparatus can be turned off later if the tapping area 100 is continuously tapped twice within a second. Besides, another example of selecting a choice in a function menu is exemplified as following where there is only one tapping area 102. In this case, an indicating mark can be moved when the tapping area 102 is tapped once and a certain choice can be selected when the tapping area 102 is continuously tapped twice. In addition to the tapping frequency, the order of tapping can be used to control the G-sensor remote control. For example, the electric apparatus can be turned on after the first tapping and turned off after the second tapping.

In another mode, there are plural tapping areas, each of which is assigned with a certain definition for controlling the remote controller. In the example of selecting a choice in a function menu mentioned above, one tapping area 104 can be assigned with a function of moving an indicating mark while another tapping area 102 can be assigned with a function of selecting a choice. Tapping the tapping area 104 will move the indicating mark to a desired choice while tapping the tapping area 102 will have the choice selected. Moreover, three or more tapping areas can be used cooperatively to set or correct time shown on the remote controller or the electric apparatus. Furthermore, in this example, the time can be set or corrected by tapping two or more tapping areas continuously in a certain sequence, such as tapping the tapping areas 100, 102, 104 successively.

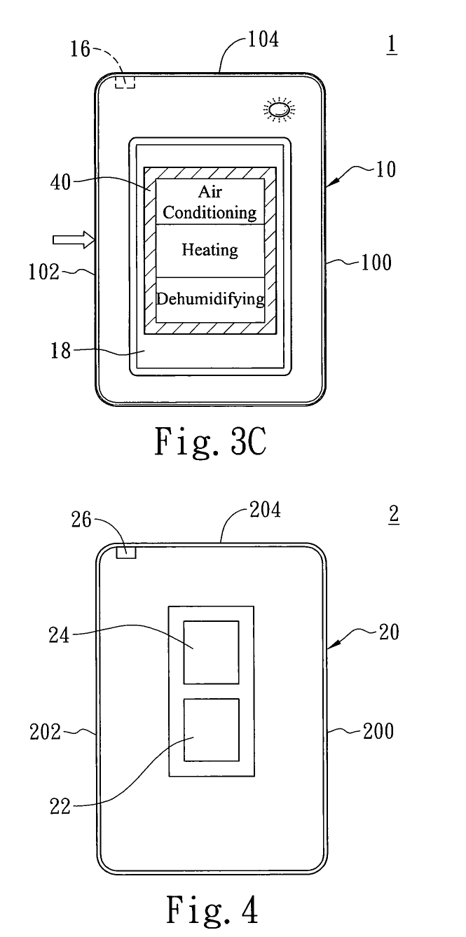

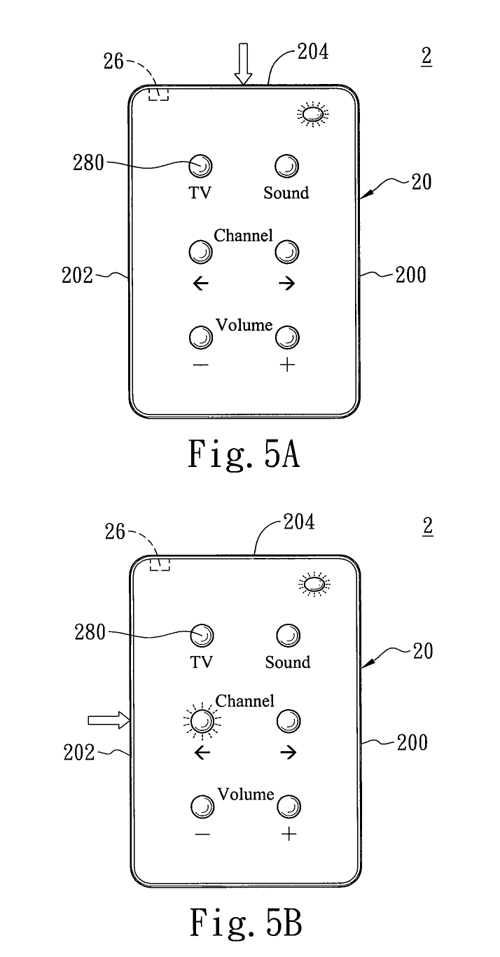

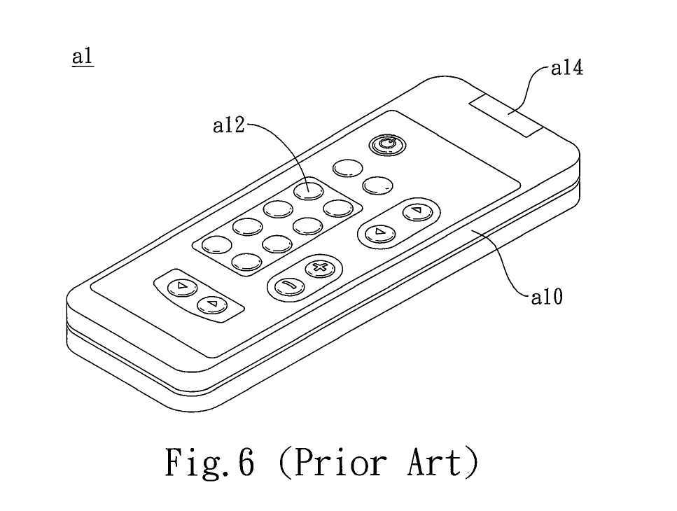

Please refer to FIGS. 4, 5A, and 5B showing a second embodiment of a G-sensor remote controller according to the present invention. The G-sensor remote controller 2 comprises a main body 20, a G-sensor 22, a microprocessor 24, and a transmitting unit 26. The main body is provided with three tapping areas 200, 202, 204 thereon. Compared with the first embodiment, the main body 20 of the second embodiment is provided with an indicating unit for indicating selectable functions thereon.

In practice, it is exemplified to use plural display lights as the indicating unit. As shown in FIGS. 5A and 5B, the indicating unit 28 includes a plurality of display lights 280. These display lights represent various functions including: turning on or off a television or a sound system, changing channel forward or backward, or turning the volume up or down. The display lights 280 will be enlightened alternatively when a user taps the tapping area 204. When the display light 280 that represents a desired function is enlightened, the user can execute that function by tapping another tapping area 202 and transmit the control command to the electric apparatus in control by the transmitting unit 26.

As disclosed in the above description and attached drawings, the present invention can provide a G-sensor controller, where at least a G-sensor is provided within the main body of the remote controller and people can conveniently use the remote controller just by their tapping action to control the remote controller itself or other electric apparatuses. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A G-sensor (gravity sensor) remote controller, which is characterized in that at least a G-sensor and a microprocessor are provided within the main body of the remote controller, wherein:
each G-sensor provided in the main body of the remote controller is for sensing the tapping action of a user to produce sensing signals;
the microprocessor provided in the main body of the remote controller is electrically connected with the G-sensor and for processing the sensing signals from the G-sensor to control the function setting of the remote controller.

2. The G-sensor remote controller as claimed in claim 1, wherein the G-sensor is located near the external surface of the main body of the remote controller.

3. The G-sensor remote controller as claimed in claim 1, wherein different sensing signals are produced by the G-sensor according to the area of the main body of the remote controller the user taps.

4. The G-sensor remote controller as claimed in claim 3, wherein different sensing signals are produced by the G-sensor according to the tapping frequency within a period of time.

5. The G-sensor remote controller as claimed in claim 1, wherein one G-sensor is used for sensing the tapping action of the user to turn on or off electric apparatuses.

6. The G-sensor remote controller as claimed in claim 1, further comprising a screen provided on the main body of the remote controller.

7. The G-sensor remote controller as claimed in claim 6, wherein at least one G-sensor is used for sensing the tapping action of the user to set the time displayed on the screen.

8. The G-sensor remote controller as claimed in claim 6, further comprising a transmitting unit provided in the main body of the remote controller for transmitting control commands to electric apparatuses, wherein the control commands are produced by the microprocessor according to the processed sensing signals to control the electric apparatuses; and one G-sensor is for sensing the tapping action of the user to display at least one function menu and to select options of the at least one function menu.

9. The G-sensor remote controller as claimed in claim 1, further comprising at least an indicator and a transmitting element; the indicator being provided on the external surface of the remote controller for indicating at least one function under the control of the remote controller; and the transmitting element being provided in the main body of the remote controller for transmitting control commands to electric apparatuses, wherein the control commands are produced by the microprocessor according to the processed sensing signals

10. The G-sensor remote controller as claimed in claim 9, wherein at least one G-sensor is for sensing the tapping action of the user to select an indicator to execute the function indicated by the selected indicator.

11. A G-sensor remote controller for control electric apparatuses, comprising:
a main body;
at least a G-sensor, provided in the main body of the remote controller and used for sensing the tapping action of a user to produce sensing signals;
a microprocessor, provided in the main body and electrically connected with the G-sensor and used for processing the sensing signals from the G-sensor to produce control commands controlling corresponding electric apparatuses; and
a transmitting unit for transmitting the control commands to the electric apparatuses.

12. The G-sensor remote controller as claimed in claim 11, wherein the G-sensor is located near the external surface of the main body of the remote controller.

13. The G-sensor remote controller as claimed in claim 11, wherein different sensing signals are produced by the G-sensor according to the area of the main body of the remote controller the user taps.

14. The G-sensor remote controller as claimed in claim 13, wherein different sensing signals are produced by the G-sensor according to the tapping frequency within a period of time.

15. The G-sensor remote controller as claimed in claim 11, wherein one G-sensor is for sensing the tapping action of the user to turn on or off the electric apparatuses.

16. The G-sensor remote controller as claimed in claim 11, further comprising a screen provided on the main body of the remote controller.

17. The G-sensor remote controller as claimed in claim 16, wherein at least one G-sensor is for sensing the tapping action of the user to set the time displayed on the screen.

18. The G-sensor remote controller as claimed in claim 16, wherein one G-sensor is for sensing the tapping action of the user to display at least one function menu and to select the options of the function menu.

19. The G-sensor remote controller as claimed in claim 11, further comprising at least an indicator provided on the external surface of the remote controller for indicating at least one function under the control of the remote controller.

20. The G-sensor remote controller as claimed in claim 19, wherein at least one G-sensor is for sensing the tapping action of the user to select an indicator to execute the function indicated by the selected indicator.
